(19) United States
(12) Patent Application Publication
(10) Pub. No.: US 2024/0211760 A1
(43) Pub. Date: Jun. 27, 2024

(54) METHOD FOR PREDICTING PERFORMANCE OF SOLAR CELL STRUCTURE

(71) Applicants: Xiamen University, Xiamen (CN); TAN KAH KEE INNOVATION LABORATORY, Xiamen (CN)

(72) Inventors: Kai Huang, Xiamen (CN); Ying Jiang, Xiamen (CN); Zhuoying Jiang, Xiamen (CN); Lin Li, Xiamen (CN); Cheng Li, Xiamen (CN); Jinchai Li, Xiamen (CN); Rong Zhang, Xiamen (CN); Junyong Kang, Xiamen (CN)

(21) Appl. No.: 18/597,920

(22) Filed: Mar. 7, 2024

Related U.S. Application Data
(63) Continuation of application No. PCT/CN2021/124175, filed on Oct. 15, 2021.

(51) Int. Cl. G06N 3/08; G06N 5/022; H02S 50/10

(52) U.S. Cl. CPC G06N 3/08; G06N 5/022; H02S 50/10

(57) ABSTRACT

A method for predicting performance of solar cell structure includes: collecting and extracting input feature parameters of solar cell structures and corresponding output feature parameters; establishing corresponding data sets, and preprocessing the data sets according to a known criterion; constructing a model by utilizing a machine learning algorithm, and setting structural parameters and performing initialization training on the model; performing training optimization on the model subjected to setting the structural parameters and performing the initialization training by using a preprocessed training data set to obtain a prediction model; and inputting a preprocessed test data set of a to-be-predicted solar cell structure into the prediction model to obtain predicted values of output feature parameters of the to-be-predicted solar cell structure. The performance of solar cell structure can be rapidly predicted, which is convenient to operate and has a high accuracy.

### TECHNICAL FIELD

The disclosure relates to the field of solar cell technologies, particularly to a method for predicting performance of solar cell structure based on a machine learning algorithm model.

### BACKGROUND

A solar cell is a photovoltaic semiconductor wafer that directly utilizes sunlight to generate electric energy, and is also referred to as a “solar energy chip” or “photovoltaic cell”. Therefore, the solar cell can instantly output voltage and generate current when subjected to certain illumination conditions. The illumination conditions is called solar photovoltaic (PV) in physics, abbreviated as PV. The solar cell is mainly based on a semiconductor material, and its working principle is that photovoltaic reaction occurs after the photoelectric material absorbs sunlight energy. It can also be said that the solar cell directly converts the sunlight energy into the electric energy through a photovoltaic or photochemical effect. The solar cell can directly convert solar energy into electric energy, which is the most effective form of clean energy.

A photovoltaic cell sold on the market is mainly a monocrystalline silicon photovoltaic cell made of monocrystalline silicon. With the continuous development of the solar cell industry, other various photovoltaic cell technologies also emerge continuously. Conversion efficiency (also referred to as photovoltaic conversion efficiency or power generation efficiency) of the photovoltaic cell must be improved and production cost of the photovoltaic cell must be reduced, thereby realizing large-scale application of the photovoltaic cell. At present, when researching and developing new-type solar cells, a multi-junction solar cell has gradually become a hot spot for solar cell research with a series of advantages such as high conversion efficiency, excellent radiation resistance, stable temperature features, and easy large-scale production.

However, there exists blindness in designing multi-junction solar cell structures, e.g., performance of the multi-junction solar cell structure is improved mainly depending on researchers' experience. However, the foregoing method has obvious disadvantages, such as low efficiency, difficulty in obtaining optimal conditions by artificially selecting parameters in the simulation test, high verification cost, etc. Meanwhile, machine learning is a common research hotspot in fields of artificial intelligence and pattern recognition, and the theory and method thereof have been widely used in solving the complex problems in engineering applications and scientific fields. In the era of rapid development of Internet, if a machine learning method in artificial intelligence is applied to the design of the multi-junction solar cell structure, conversion efficiency of the multi-junction solar cell can be significantly improved.

In view of the design of new-type solar cell structures, those skilled in the related art face the following challenges: how to predict the performance of the designed solar cell structure by means of a machine learning method, and then timely adjust the design scheme of the new-type solar cell structure by means of the prediction results to obtain an electronic component composed of a solar cell or a photovoltaic cell with better conversion efficiency.

### SUMMARY

In order to overcome the defects of performance prediction in designing a new-type solar cell structure in the related art, the disclosure provides a method for predicting performance of solar cell structure, which can predict the performance of the solar cell structure by using different machine learning models, and timely adjust the design scheme of the solar cell structure according to prediction results. Therefore, the design of the solar cell structure is excellent in performance, such as better photovoltaic conversion efficiency, and service life of the solar cell is prolonged.

In an embodiment, predicting performance of solar cell structure includes the following steps:
step 1, collecting and extracting input feature parameters of solar cell structures, output feature parameters corresponding to the input feature parameters, and input feature parameters of a to-be-predicted solar cell structure; and taking the input feature parameters of solar cell structures and the output feature parameters corresponding to the input feature parameters as a training data set, and taking the input feature parameters of the to-be-predicted solar cell structure as a test data set;
step 2, preprocessing the training data set and the test data set to obtain a preprocessed training data set and a preprocessed test data set;
step 3, constructing an initial model by using a machine learning algorithm;
step 4, setting structural parameters of the initial model, and performing initialization training on the structural parameters to obtain an initialized model;
step 5, optimizing the initialized model: training the initialized model by using the preprocessed training data set to obtain a network weight and a bias, thereby obtaining a prediction model; and
step 6, inputting the preprocessed test data set into the prediction model to obtain predicted values of output feature parameters of the to-be-predicted solar cell structure (i.e., predicted performance of the to-be-predicted solar cell structure).

In an embodiment, the machine learning algorithm includes at least one selected from the group consisting of a deep learning algorithm, a multilayer perceptron algorithm, a decision tree algorithm, a linear regression algorithm, a gradient boosting regression algorithm, and a k-nearest neighbor algorithm; and the deep learning algorithm includes at least one selected from the group consisting of a convolutional neural network algorithm, a self-encoding network algorithm, and a deep belief network algorithm.

In an embodiment, each of the solar cell structures is a multi-junction solar cell structure, and includes at least one bottom cell and multiple sub-cells, and the multiple sub-cells are disposed above the bottom cell.

In an embodiment, the bottom cell includes a substrate, an emissive layer, a window layer, and a tunnel junction that are arranged sequentially in a stacking direction, and the multiple sub-cells are disposed to stack on the tunnel junction of the bottom cell; and each of the multiple sub-cells includes a back surface field layer, a substrate region, an emissive layer, and a window layer that are arranged sequentially in the stacking direction; and an upper sub-cell of the multiple sub-cells further includes a contact layer disposed on the corresponding window layer of the upper sub-cell, and each of the remaining sub-cells includes a tunnel junction disposed on the corresponding window layer thereof.

In an embodiment, the input feature parameters of the solar cell structures include, but are not limited to, a thickness of each layer of each of the solar cell structures, stacking modes between layers of the solar cell structures, a shape of each layer of each of the solar cell structures, composition materials of each layer of each of the solar cell structures, and component ratios of the composition materials; and the output feature parameters corresponding to the input feature parameters include, but are not limited to short circuit current densities, open circuit voltages, and fill factors of the solar cell structures. The input feature parameters and the output feature parameters corresponding to the input feature parameters of the solar cell structures are screened and adjusted according to a type of each of the solar cell structures. In other words, the input feature parameters and the output feature parameters corresponding to the input feature parameters of the solar cell structures can be deleted or amplified according to requirements.

In an embodiment, the preprocessing the training data set and the test data set includes the following steps: (1) screening feature data, including: screening the input feature parameters of the solar cell structures, the output feature parameters corresponding to the input feature parameters, and the input feature parameters of the to-be-predicted solar cell structure according to known physical knowledge and a relationship between the feature data; (2) data processing, including: performing normalization processing on the screened feature data to obtain processed feature data; and (3) data recombination, including: transforming or combining the processed feature data in different dimensions to improve an expressive power or reduce a complexity of the processed feature data, and to covert the processed feature data with higher dimension into the processed feature data with lower dimension, thereby to reduce redundancy or noise of the processed feature data and to improve interpretability and operability of the processed feature data.

In an embodiment, after performing normalization processing on the screened feature data, a mean value of the processed feature data is 0 and a standard deviation of the processed feature data is 1.

In an embodiment, the optimizing the initialized model further includes:
evaluating a training result of the initialized model by using a mean square error (MSE), a formula of the mean square error being as follows:

$$MSE = \frac{{\sum }_{i - 1}^{N} {( {Predict}_{i} - {Actual}_{i} )}^{2}}{N} ;$$

where Predictᵢ and Actualᵢ represent a predicted value and an actual value of an i-th sample, respectively, and N represents a data number in the preprocessed training data set.

Based on the foregoing description, compared with existing simulation software such as advanced physical models of semiconductor devices (APSYS), the method for predicting performance of the solar cell structure provided by the disclosure has the following effects.

1. According to the method for predicting performance of the solar cell structure by using different algorithm models in machine learning, it is possible to quickly predict the performance of components with different structures without considering whether the network structure fitting in the model converges or not, and then based on the prediction results, the design scheme of the solar cell structure is better optimized.

2. The neural network model constructed in the machine learning algorithm of the disclosure uses dropout and other strategies, which can effectively prevent or reduce the overfitting of the model, thereby improving the accuracy of the constructed neural network model for predicting performance of the solar cell structure.

3. In the disclosure, the data are performed machine learning, and then the corresponding neural network model is constructed; the constructed neural network model is used to predict the performance of the components of different solar cell structures with different material proportioning and structure. Therefore, a rule of a relatively complex physical structure of the solar cell structure can be explored from the data, and the operation is simple and convenient.

Other features and beneficial effects of the disclosure will be set forth in the following description. Specially, some of the features are obvious from the specification of the disclosure, or can be understood by implementing the disclosure. The objectives and other beneficial effects of the disclosure may be implemented and obtained by the structures particularly pointed out in the disclosure.

### BRIEF DESCRIPTION OF DRAWINGS

In order to more clearly illustrate embodiments of the disclosure or technical solutions in the related art, attached drawings that need to be used in the embodiments or the related art are briefly described below. Apparently, the attached drawings in the following description are some of the embodiments according to the disclosure, and other drawings can be obtained by those skilled in the related art according to the attached drawings without creative efforts. Positional relationships of the attached drawings described below are based on the directions indicated by the components in the attached drawings, unless otherwise specified.

FIG. 1 illustrates a schematic diagram of a solar cell structure according to an embodiment of the disclosure.

FIG. 2 illustrates a schematic diagram of a classical neural network model according to the disclosure.

FIG. 3 illustrates a schematic diagram of a convolutional neural network used in predicting performance of the solar cell structure according to the disclosure.

FIG. 4 illustrates a flowchart of a method for predicting performance of the solar cell structure according to an embodiment of the disclosure.

### REFERENCE NUMERALS

1—multi-junction solar cell; 10—bottom cell; 11—substrate; 12—emissive layer; 13—window layer; 14—tunnel junction;
A—sub-cell set; 20—sub-cell; 21—back surface field layer; 22—substrate region; 23—emissive layer; 24—window layer; 25—tunnel junction; 26—contact layer.

### DETAILED DESCRIPTION OF EMBODIMENTS

In order to make the objectives, technical solutions and advantages of the embodiments of the disclosure clearer, the technical solutions in the embodiments of the disclosure will be clearly and completely described below with reference to the attached drawings in the embodiments of the disclosure. All other embodiments obtained by those skilled in the related art based on the embodiments of the disclosure without creative efforts shall fall within the scope of the protection of the disclosure.

In the description of the disclosure, it should be noted that all of terms (including technical terms and scientific terms) used in the disclosure have the same meaning as commonly understood by those skilled in the related art to which the disclosure belongs, and cannot be understood as a limitation to the disclosure. It should be further understood that the terms used in the disclosure should be understood to have a meaning that is consistent with the meaning of these terms in the context of the specification and the related art, and should not be interpreted in an idealized or overly formal sense, except as expressly defined in the disclosure.

In researching and developing a new-type solar cell, a multi-junction solar cell is a solar cell with high conversion efficiency. Each cell is composed of multiple thin films generated by molecular beam epitaxy or organic metal chemical vapor deposition. Different semiconductors composed of these films have different feature energy gaps, and these energy gaps can absorb electromagnetic wave energy at a specific frequency in the absorption spectrum. The generated semiconductors are particularly designed to absorb lights at most of frequency in the sunlight to generate more energy. The multi-junction solar cell has been widely used in the field of space after nearly ten years of development, and the recorded efficiency is also continuously refreshed. In order to facilitate the description, it is understood that in the description of the embodiments of the disclosure, the structure of the multi-junction solar cell is taken as an example, a method for predicting performance of a multi-junction solar cell structure is explained by using different algorithm models in machine learning.

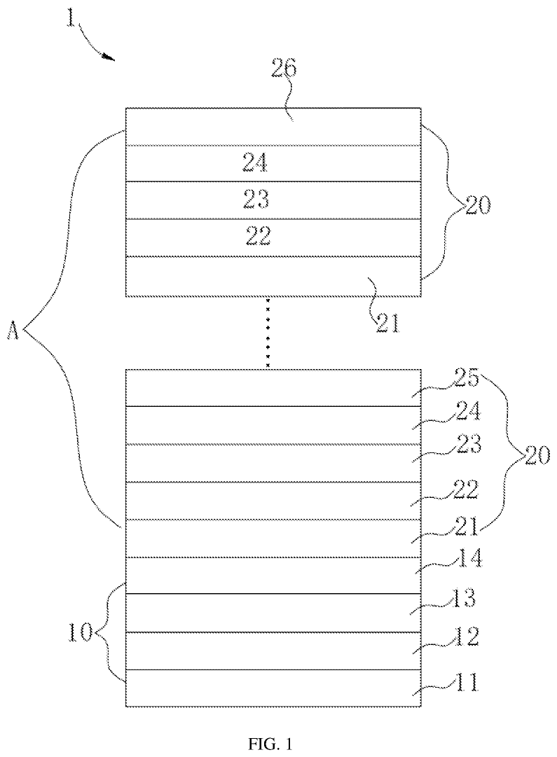

With reference to FIG. 1, it illustrates a schematic diagram of a solar cell structure according to an embodiment of the disclosure. As shown in FIG. 1, the solar cell structure is a multi-junction solar cell structure, and the multi-junction solar cell structure includes multiple PN junctions (referred to an interface or a boundary between two semiconductor material types, also abbreviated as pn junctions). The multi-junction solar cell structure 1 mainly includes at least one bottom cell 10 and multiple sub-cells 20, and the multiple sub-cells 20 are located above the bottom cell 10 and disposed to sequentially stack above the bottom cell 10. The bottom cell 10 includes a substrate 11, an emissive layer 12, a window layer 13, and a tunnel junction 14 that are stacked sequentially (from bottom to top illustrated in FIG. 1). Meanwhile, the multiple sub-cells 20 can form a sub-cell set A, and the sub-cell set A is disposed to stack above the tunnel junction 14 of the bottom cell 10. Each sub-cell 20 of the sub-cell set A may include a back surface field layer 21, a substrate region 22, an emissive layer 23, a window layer 24, and a tunnel junction 25 that are stacked sequentially (from bottom to top in FIG. 1). Specially, the tunnel junction 25 of a topmost or an uppermost sub-cell 20 is replaced by a contact layer 26.

Further, with reference to FIG. 1, the back surface field layer 21 of the sub-cell 20 facing towards the bottom cell 10 is in contact with the tunnel junction 14 of the bottom cell 10 and is disposed to stack above the tunnel junction 14 of the bottom cell 10. In the multiple sub-cells 20, the back surface field layer 21 of the next sub-cell 20 is in contact with a tunnel junction 25 of the previous sub-cell 20 adjacent thereto. To facilitate contact between the multi-junction solar cell 1 and other components, the tunnel junction 25 of the topmost or uppermost sub-cell 20 in the sub-cell set A is replaced by the contact layer 26. The contact layer 26 of the sub-cell 20 can be used as a current guide layer, and can also be a material layer connecting the multi-junction solar cell 1 to an electrode, and can further be used as an ohmic contact. The contact layer 26 can form a good ohmic contact with a specific electrode metal material, thereby reducing power loss caused by series resistance of the contact layer 26.

With progress and evolution of research and development, there are many types of methods for machine learning, and the methods for machine learning can be divided into various classification methods according to different emphases. Based on classification by learning strategies, machine learning can be divided into machine learning for simulating human brain and machine learning directly using mathematical methods. Machine learning for simulating human brain can be further divided into symbol learning and neural network learning (or connection learning). Machine learning directly using mathematical methods mainly includes statistical machine learning. Based on classification by learning methods, machine learning can be classified into inductive learning, deduction learning, analogy learning, and analysis learning. The inductive learning can further be classified into symbol inductive learning (such as example learning, decision tree learning) and function inductive learning (also referred to discovery learning, such as neural network learning, example learning, discovery learning, statistical learning). Based on classification by learning modes, machine learning can be divided into supervised learning (also referred to a subcategory of machine learning and artificial intelligence that uses labeled datasets to train algorithms to classify or predict data), unsupervised learning (also referred to using algorithms to analyze and cluster unlabeled datasets without human intervention) and reinforcement learning (also referred to a type of machine learning technique that enables an agent to learn in an interactive environment by trial and error using feedback from its own actions and experiences). Based on classification by data forms, machine learning can be divided into structured learning and unstructured learning. Based on classification by learning objectives, machine learning can be classified into concept learning, rule learning, function learning, category learning, and Bayesian network learning.

More commonly used algorithms in machine learning include, but are not limited to, a decision tree algorithm, a naive Bayes algorithm, a support vector machine algorithm, a random forest algorithm, an artificial neural network algorithm, a Boosting and Bagging algorithm, an association rule algorithm, an expectation maximization (EM) algorithm, and a deep learning algorithm. Among them, the deep learning (DL) algorithm is used as a new research direction in the field of machine learning (ML), which can learn an essential rule and represent a hierarchy of sample data. A final goal of the deep learning algorithm is to make a machine capable of analyzing and learning as human beings, and capable of recognizing data such as text, images and sounds.

Different deep learning models are mainly constructed based on a neural network. The neural network is an algorithm mathematical model that mimics behavior features of a biological neural network, which can generate an output after receiving multiple inputs. With the continuous development of the neural network, iterative updating of the deep learning algorithm, the structure of a neural network model is also continuously adjusted and optimized; especially the methods in feature extraction and feature selection can be further improved. The methods can map any complex nonlinear relationship, have strong robustness, memory capability, self-learning capability, etc., and have a wide application in many aspects, such as classification, prediction, mode recognition, etc.

According to the foregoing, in the embodiments of the disclosure, the adopted machine learning algorithm can be a deep learning algorithm, a neural network (NN) algorithm, a multilayer perceptron algorithm, a decision tree algorithm, a linear regression algorithm, a gradient boosting regression (GBR) algorithm, and a K-nearest neighbor (KNN) algorithm. The deep learning algorithm can be a convolutional neural network algorithm, a recurrent neural network algorithm, a self-encoding network algorithm, and a deep belief network algorithm. The following will explain how to apply the machine learning model to predict performance of a new-type solar cell structure with reference to processes of predicting the performance of the multi-junction solar cell structure by using different machine learning algorithm models.

Embodiment 1: The performance of the multi-junction solar cell structure is predicted by using the convolutional neural network algorithm of the deep learning algorithm.

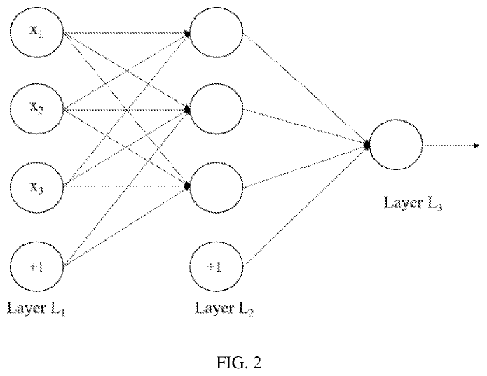

With reference to FIG. 2, it illustrates a schematic diagram of a classical neural network model according to the disclosure. The neural network (NN) is an algorithm mathematical model for simulating an actual human neural network to process information, is a complex network system formed by a large number of simple processing units (referred to as neurons) that are connected to each other, and is also a highly complex nonlinear dynamic learning system. A neuron is a multi-input single-output information processing unit, which is non-linear to the information processing. The neural network is a model in machine learning.

Analogy to the human actual neural network, it can be understood that the neural network is composed of neurons and connections (also referred to as synapses) between nodes, and each neural network unit is also referred to as a sensor, which receives multiple inputs to generate an output. An actual neural network decision model is often a multi-layer network composed of multiple sensors. As shown in FIG. 2, the classical neural network model is mainly composed of an input layer, a hidden layer, and an output layer; and LayereL₁ represents the input layer, LayereL₂ represents the hidden layer or a hiding layer, and LayereL₃ represents the output layer. Based on the advantages of the neural network model on the machine learning, in the process of designing the multi-junction solar cell structure, feature factors influencing photovoltaic efficiency of electronic components by the multi-junction solar cell structure can be efficiently and accurately predicted by means of the neural network model, and the design scheme of the multi-junction solar cell structure is timely adjusted according to the prediction results to meet an expected overall function effect.

As shown in FIG. 2, in a feed forward neural network, information moves forward only in one direction, such as transmitting from an input node, through a hidden node (if existing the hidden layer), to an output node. If can be found that there is no circle or loop in the network. In the field of machine learning, a typical deep learning model may mainly include three types: (1) a neural network system based on convolutional operations, such as the convolutional neural network (CNN); (2) a self-encoding neural network based on multi-layer neurons, including a self-encoding (auto encoder) network and a sparse coding network; (3) pre-training in a multi-layer self-encoding neural network mode, and then optimizing the deep belief network (DBN) with neural network weight by combining recognition information.

In addition to the above three typical deep learning models, the deep learning model can be a recurrent neural network, a recursive neural network, etc.

The convolutional neural network (CNN) is a deep feed forward neural network with features such as local connection and weight sharing. The convolutional neural network is composed of three parts: the first part is an input layer; a second part is a combination of n convolutional layers and a pooling layer (also referred to as a hidden layer and a hiding layer); and a third part is composed of a fully connected multi-layer perceptron classifier (also referred to as a fully connected layer). The convolutional neural network includes a feature extractor composed of a convolutional layer and a sub-sampling layer. In the convolutional layer of the convolutional neural network, one neuron is only connected to partial neurons disposed on an adjacent layer. One convolutional layer of the CNN usually includes multiple feature maps, each feature map is composed of some neurons arranged in a rectangular shape, the neurons in the same feature map share the weight, and the shared weight is a convolution kernel. The convolution kernel is generally initialized in a form of a random decimal matrix, and then the convolution kernel will learn to be a reasonable weight during the training process of the network. The shared weight (also referred to as the convolution kernel) can reduce the connection between layers of the network while reducing the risk of overfitting. The sub-sampling is also called pooling, usually with two forms, such as mean pooling and max pooling. The sub-sampling layer is also called a pooling layer, and the function thereof is to perform feature selection and reduce the number of features, thereby reducing the number of parameters. The sub-sampling can be regarded as a special convolution process. The convolution and the sub-sampling greatly simplify the complexity of the model and reduce the parameters of the model.

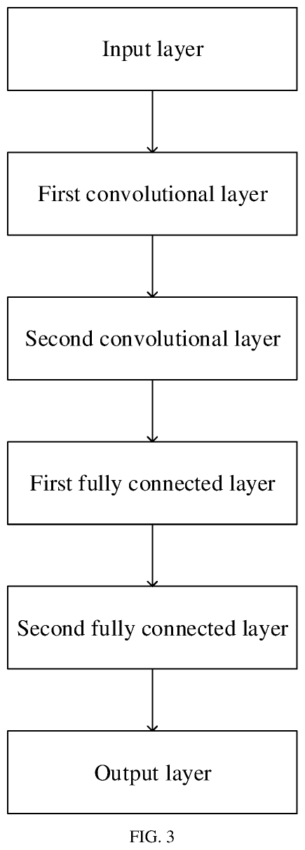

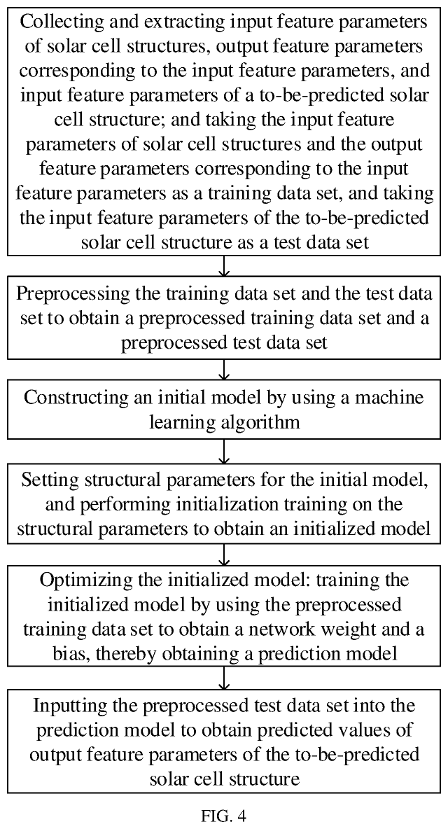

With reference to FIG. 3 and FIG. 4 combined with FIG. 1 and FIG. 2, FIG. 3 illustrates a schematic diagram of a convolutional neural network used in predicting performance of the solar cell structure according to the disclosure; and FIG. 4 illustrates a flowchart of a method for predicting performance of the solar cell structure according to an embodiment of the disclosure. In the embodiment of FIG. 3, the convolutional neural network algorithm is used as an example to further explain and describe the embodiment. The process steps for predicting the performance of a multi-quantum well structure of a blue-light multi-junction solar cell by using the convolutional neural network of the deep learning algorithm are as follows.

Step 1: input feature parameters of the multi-junction solar cell structure and output feature parameters corresponding to the input feature parameters are collected and extracted, and corresponding data sets are constructed for the collected parameters.

In the process of collecting and extracting the input feature parameters of the multi-junction solar cell structure, the input feature parameters of the multi-junction solar cell structure need to be screened. During screening process, the input feature parameters screened for data acquisition and extraction or selection usually have a great influence on predicted values of the corresponding output feature parameters of the multi-junction solar cell structure. The screened input feature parameters of the multi-junction solar cell structure include, but are not limited to, the thickness of each layer of the multi-junction solar cell structure, stacking modes between layers of the multi-junction solar cell structure, a shape of each layer of the multi-junction solar cell structure, composition materials of each layer of the multi-junction solar cell structure, and component ratios of the composition materials. The screened output feature parameters of the multi-junction solar cell structure include, but are not limited to, a short circuit current density (J_{SC}) of the multi-junction solar cell structure, an open circuit voltage (V_{OC}) of the multi-junction solar cell structure, a fill factor (FF) of the multi-junction solar cell structure, etc. In should be noted that input feature parameters of a to-be-predicted multi-junction solar cell structure also need to be screened.

Then, the corresponding data sets are constructed for the screened input feature parameters and the output feature parameters of the multi-junction solar cell structure as well as the screened input feature parameters of the to-be-predicted multi-junction solar cell structure, and data set parameters are designed correspondingly. The data sets can be divided into a training data set (i.e., the screened input feature parameters of the multi-junction solar cell structure and the screened output feature parameters corresponding to the input feature parameters) and a test data set, and the data sets are preprocessed. The data set parameters can represent the inside complex multi-junction solar cell structure, so as to collect and record a large amount of the data of the multi-junction solar cell structure. Therefore, each of the data set parameters of the multi-junction solar cell structure can be used as a sample, and the multiple data set parameters of the multi-junction solar cell structure can be used as a sample set. Each sample or the sample set can be used as an input layer of the neural network.

Step 2: the training data set and the test data set constructed in the step 1 are preprocessed to obtain a preprocessed training data set and a preprocessed test data set. The pre-processing method includes the following steps:

(1) In the constructed data sets, the input feature parameters of the solar cell structures, the output feature parameters corresponding to the input feature parameters, and the input feature parameters of the to-be-predicted multi-junction solar cell structure are screened to obtain feature data according to known physical knowledge and a relationship (i.e., correlation coefficients) between the feature data.

(2) Normalization processing is performed on the screened feature data, and a specific calculation formula of the normalization processing is as follows:

$${x}^{′} = \frac{x - μ}{σ} ,$$

where x represents a training value of a feature in the dataset before normalization, x′ represents a normalized value of the feature, y represents a mean value of the feature, and σ represents a standard deviation of the feature. The normalization processing is performed on the screened input feature data, so that the mean value of the processed feature data in each dimension is 0, the standard deviation of the processed feature data is 1, and the input feature data obeys standard normal distribution.

(3) Data recombination: the processed feature data is recombined in different dimensions to improve the expressive power or reduce the complexity of the processed feature data, and to convert the processed feature data with higher dimension into the processed feature data with lower dimension, thereby to reduce the redundancy or noise of the processed feature data, and improve the interpretability and operability of the processed feature data, and then is performed multi-batch division to improve efficiency. More specifically, the entire sample is divided into equal subsets, and the parameters are updated for each subset.

It should be further noted that, since input dimensions required in a two-dimensional convolutional neural network are 4D (containing: samples, rows, cols, channels) and the training data set in the embodiment is an array read from a txt form file, an arrangement mode of the training data set needs to be adjusted, so that the training data set is matched with the input dimensions of the two-dimensional convolutional neural network.

Step 3: a neural network model (also referred to as an initial model) is constructed by using a convolutional neural network algorithm based on the machine learning algorithm.

With reference to FIG. 3, in the embodiment, the convolutional neural network model constructed by using the convolutional neural network mainly includes an input layer, multiple convolutional layers, multiple fully connected layers, and an output layer, and the foregoing layers are sequentially connected. The input layer can be configured to input the feature data or the data set of the input feature parameters of the sample or the sample set of the multi-junction solar cell structure, such as the input feature parameters in the preprocessed training data set and the preprocessed test data set.

As shown in FIG. 3, two convolutional layers (i.e., a first convolutional layer and a second convolutional layer) are connected behind the input layer, and each convolutional layer includes an activation function.

The two convolutional layers perform corresponding convolution calculation on the feature map through the convolution kernel to extract the feature map, and a specific convolution process of the first convolutional layer can be expressed as follows:

$${x}^{( 1 )} = Σ {x}_{i}^{( 1 )} * {ω}^{( 1 )} + {b}^{( 1 )} ,$$

where x⁽¹⁾ represents the first convolution layer, xᵢ⁽¹⁾ represents the i-th position in the input graph x, * represents the convolution calculation of the matrix, ω⁽¹⁾ represents a neuron weight of the first convolutional layer, and b⁽¹⁾ represents a bias of the first convolutional layer. Generally, a size of an input matrix (also referred to as an input feature map) is ω, a size of the convolution kernel is k, a stride is s, and a number of zero padding layers is P, and a calculation formula for a size of the feature map generated after the convolution is as follows:

$${ω}^{′} = \frac{ω + 2 p - k}{s} + 1.$$

In the embodiment, the zero padding operation is performed on the input feature map, thereby making the size of the feature map generated after the convolution is unchanged.

The activation function in the convolutional layer is a rectified linear unit (ReLU), and a mathematical formula of the rectified linear unit is: f(x)=max(0, x), which can achieve a nonlinear transformation of the input feature map.

The second convolutional layer performs further feature extraction on the generated feature map subjected to the activation function in the first convolutional layer, and a feature map output in the second convolutional layer is activated by a rectified linear unit (ReLU) in an activation layer of the second convolutional layer and then is transmitted to the next part, such as the fully connected layer.

The activation function in the convolutional layers is the rectified linear unit (ReLU). The first convolution layer performs the feature extraction on the input feature map with a shape of (5, 6, 1) to obtain the generated output feature map with a size of (5, 6, 16). The size of the convolution kernel in the first convolution layer is 3*3, a number of the convolution kernel is 16, and padding mode selects same. The second convolutional layer performs the feature extraction on the generated output feature map subjected to the activation function in the first convolution layer, and outputs the feature map with a size of (5, 6, 32). The size of the convolution kernel in the second convolution layer is 3*3, a number of the convolution kernel is 32, and padding mode selects same. The output feature map in the second convolution layer is activated by the rectified linear unit (ReLU) in the activation layer of the second convolution layer and then is transmitted to the next part, such as the fully connected layer.

As shown in FIG. 3, the convolutional neural network model has two fully connected layers. The aforementioned feature map activated by the activation layer of the second convolution layer is changed into a size of (960) connected to a first fully connected layer provided with 128 neurons after a flatten operation. Since fewer training samples are used in the embodiment and the overfitting needs to be suppressed or reduced, the dropout strategy is used, namely, each training process randomly inactivates 20% of the neurons. In view of the feature map subjected to the activation function in the second convolution layer, the final prediction is completed by means of the second fully connected layer.

Step 4: structural parameters of the constructed convolutional neural network model (also referred to as the initial model) are set and initialization training is performed on the set structural parameters to obtain an initialized convolutional neural network model.

A method for initialization training the network structure parameters set in the convolutional neural network model is as follows: for the first convolutional layer, a step size is set to 1, the number of output channels is 16, and a fill mode is set to be a same padding; and for the second convolution layer, a step size is set to 1, the number of output channels is 32, and a fill mode is set to be a same padding. Weights in the first convolutional layer and the second convolutional layer are initialized to be a truncated normal distribution noise with a mean value of 0 and a standard deviation of 0.1, all of the biases in the network are initialized to a constant, and the constant is 1. A learning rate is set within a numerical range according to the features of the training samples, and a batch size of the training samples is determined; and the convolutional neural network model is repeatedly trained according to the setting of the training samples, and then a total number of times of repeated training is determined, thereby completing the initialization training of the convolutional neural network model. Specially, the numerical range of the learning rate is set from 0.00001 to 0.1, and the total number of times of repeated training is 100-500 times.

Further, in the embodiment, the learning rate of the training samples is set to be 0.0001. The batch size of the training samples is set to 16, that is, 16 feature maps are sent into the convolutional neural network during each time of the training, and then an average loss of all the training samples in the same batch is calculated. The total number of times of the repeated training is 300 times, and a stochastic gradient descent (SGD) algorithm is selected to perform initial optimization on the constructed convolutional neural network model.

Step 5: the initialized convolutional neural network model is trained and optimized by using the input feature parameters of the multi-junction solar cell structure preprocessed in the step 2, and a network weight and a bias of the initialized convolutional neural network model are obtained and stored, so as to obtain a convolutional neural network prediction model. Specially, the preprocessed training data set composed of the input feature parameters of the multi-junction solar cell structure.

In the machine learning, a loss function is used to measure a loss (difference) between a model output value and a target value. Based on the above, in the step 5, the loss function of the convolutional neural network model during the training process is evaluated by using a mean square error (MSE), so as to determine the quality of a training result of the convolutional neural network model. A formula of the mean square error formula is as follows:

$$MSE = \frac{{\sum }_{i - 1}^{N} {( {Predict}_{i} - {Actual}_{i} )}^{2}}{N} ;$$

where Predictᵢ and Actualᵢ represent a predicted value and an actual value of an i-th sample, respectively, and N represents a data number in the preprocessed training data set. The calculated MSE is closer to 0, indicating that the training and optimization result of the convolutional neural network prediction model is better, and an accuracy of output results of the convolutional neural network prediction model is higher. Therefore, when the performance of the multi-junction solar cell structure is predicted by using the convolutional neural network prediction model obtained after training and optimization, the accuracy of the obtained prediction values is higher.

Step 6: the preprocessed test data set containing the input feature parameters of the to-be-predicted multi-junction solar cell structure is used as an input layer to input into the convolutional neural network prediction model, so as to output predicted values of output feature parameters of the to-be-predicted multi-junction solar cell structure. The predicted values of output feature parameters of the to-be-predicted multi-junction solar cell structure include, but are not limited to, the short circuit current density (J_{SC}), the open circuit voltage (V_{OC}), and the fill factor (FF) of the to-be-predicted multi-junction solar cell structure.

Embodiment 2: The performance of the multi-junction solar cell structure is predicted by using the support vector regression (SVR) algorithm.

Step 1: input feature parameters of the multi-junction solar cell structure and output feature parameters corresponding to the input feature parameters are collected and extracted, and corresponding data sets are constructed for the collected parameters.

In the process of collecting and extracting the input feature parameters of the multi-junction solar cell structure, the input feature parameters of the multi-junction solar cell structure need to be screened. During screening process, the input feature parameters screened for data acquisition and extraction or selection usually have great influence on predicted values of the corresponding output feature parameters of the multi-junction solar cell structure. The screened input feature parameters of the multi-junction solar cell structure include, but are not limited to, a thickness of each layer of the multi-junction solar cell structure, stacking modes between layers of the multi-junction solar cell structure, a shape of each layer of the multi-junction solar cell structure, composition materials of each layer of the multi-junction solar cell structure, and component ratios of the composition materials. The screened output feature parameters of the multi-junction solar cell structure include, but are not limited to, a short circuit current density (J_{SC}) of the multi-junction solar cell structure, an open circuit voltage (V_{OC}) of the multi-junction solar cell structure, a fill factor (FF) of the multi-junction solar cell structure, etc. It should be noted that input feature parameters of a to-be-predicted multi-junction solar cell structure also need to be screened.

Then, the corresponding data sets are constructed for the screened input feature parameters and the output feature parameters of the multi-junction solar cell structure as well as the screened input feature parameters of the to-be-predicted multi-junction solar cell structure, and data set parameters are designed correspondingly. The data sets can be divided into a training data set (i.e., the screened input feature parameters of the multi-junction solar cell structure and the screened output feature parameters corresponding to the input feature parameters) and a test data set (i.e., the screened input feature parameters of the to-be-predicted multi-junction solar cell structure), and the data sets are preprocessed. The data set parameters can represent the inside complex multi-junction solar cell structure, so as to collect and record a large amount of the data of the multi-junction solar cell structure. Therefore, each of the data set parameters of the multi-junction solar cell structure can be used as a sample, and the multiple data set parameters of the multi-junction solar cell structure can be used as a sample set. Each sample or the sample set can be used as an input layer of the neural network (i.e., SVR).

Step 2: the training data set and the test data set constructed in the step 1 are preprocessed to obtain a preprocessed training data set and a preprocessed test data set. The pre-processing method includes the following steps:

(1) In the constructed data sets, the input feature parameters of the solar cell structures, the output feature parameters corresponding to the input feature parameters, and the input feature parameters of the to-be-predicted multi-junction solar cell structure are screened to obtain feature data according to known physical knowledge and a relationship (i.e., correlation coefficients) between the feature data.

(2) Normalization processing is performed on the screened feature data, and a specific calculation formula of the normalization processing is as follows:

$${x}^{′} = \frac{x - μ}{σ} ,$$

where μ represents a mean value of the samples, and σ represents a standard deviation of the samples. The normalization processing is performed on the screened input feature data, so that a mean value of the processed feature data in each dimension is 0, a standard deviation of the processed feature data is 1, and the input feature data obeys standard normal distribution.

(3) Data recombination: the processed feature data is recombined according to a size of each of the processed feature data, and then is performed multi-batch division.

It should be further noted that, since input dimensions required in a two-dimensional convolutional neural network are 4D (containing: samples, rows, cols, channels) and the training data set in the embodiment is an array read from a txt form file, an arrangement mode of the training data set needs to be adjusted, so that the training data set is matched with the input dimensions of the two-dimensional convolutional neural network.

Step 3: a support vector regression model is constructed by using the support vector regression algorithm based on the machine learning algorithm.

Step 4: structural parameters of the constructed support vector regression model are set and initialization training is performed on the set structural parameters to obtain an initialized support vector regression model.

A method for setting the structural parameters of the constructed support vector regression model includes: using a linear kernel algorithm, a degree of a polynomial kernel function of 3, a tolerance factor of 0.001, and a penalty coefficient of 0.8.

Step 5: the initialized support vector regression model is trained and optimized by using the input feature parameters of the multi-junction solar cell structure preprocessed in the step 2, and a network weight and a bias of the initialized support vector regression model are obtained and stored, so as to obtain a support vector regression prediction model. Specially, the preprocessed training data set composed of the input feature parameters of the multi-junction solar cell structure and the screened output feature parameters corresponding to the input feature parameters.

In the embodiment, a root mean square error is used to measure a loss (gap) between a model output value and a target value. Based on the above, in the step 5, the loss function of the support vector regression model during the training process is evaluated by using a mean square error (MSE), so as to determine the quality of a training result of the support vector regression model. A formula of the mean square error formula is as follows:

$$MSE = \frac{{\sum }_{i - 1}^{N} {( {Predict}_{i} - {Actual}_{i} )}^{2}}{N} ;$$

where Predictᵢ and Actualᵢ represent a predicted value and an actual value of an i-th sample, respectively, and N represents a data number in the preprocessed training data set. The calculated MSE is closer to 0, indicating that the training and optimization result of the support vector regression model is better, and an accuracy of output results of the support vector regression prediction model is higher. Therefore, when the performance of the multi-junction solar cell structure is predicted by using the support vector regression prediction model obtained after training and optimization, the accuracy of the obtained prediction values is higher.

Step 6: the preprocessed test data set containing the input feature parameters of the to-be-predicted multi-junction solar cell structure is used as an input layer to input into the support vector regression prediction model, so as to output predicted values of output feature parameters of the to-be-predicted multi-junction solar cell structure. The predicted values of output feature parameters of the to-be-predicted multi-junction solar cell structure include, but are not limited to, the short circuit current density (J_{SC}), the open circuit voltage (V_{OC}), and the fill factor (FF) of the to-be-predicted multi-junction solar cell structure.

Embodiment 3: The performance of the multi-junction solar cell structure is predicted by using the k-nearest neighbor (KNN) algorithm.

Step 1: input feature parameters of the multi-junction solar cell structure and output feature parameters corresponding to the input feature parameters are collected and extracted, and corresponding data sets are constructed for the collected parameters.

In the process of collecting and extracting the input feature parameters of the multi-junction solar cell structure, the input feature parameters of the multi-junction solar cell structure need to be screened. During screening process, the input feature parameters screened for data acquisition and extraction or selection usually have great influence on predicted values of the corresponding output feature parameters of the multi-junction solar cell structure. The screened input feature parameters of the multi-junction solar cell structure include, but are not limited to, a thickness of each layer of the multi-junction solar cell structure, stacking modes between layers of the multi-junction solar cell structure, a shape of each layer of the multi-junction solar cell structure, composition materials of each layer of the multi-junction solar cell structure, and component ratios of the composition materials. The screened output feature parameters of the multi-junction solar cell structure include, but are not limited to, a short circuit current density (J_{SC}) of the multi-junction solar cell structure, an open circuit voltage (V_{OC}) of the multi-junction solar cell structure, a fill factor (FF) of the multi-junction solar cell structure, etc. It should be noted that input feature parameters of a to-be-predicted multi-junction solar cell structure also need to be screened.

Then, the corresponding data sets are constructed for the screened input feature parameters and the output feature parameters of the multi-junction solar cell structure as well as the screened input feature parameters of the to-be-predicted multi-junction solar cell structure, and data set parameters are designed correspondingly. The data sets can be divided into a training data set (i.e., the screened input feature parameters of the multi-junction solar cell structure and the screened output feature parameters corresponding to the input feature parameters) and a test data set (i.e., the screened input feature parameters of the to-be-predicted multi-junction solar cell structure), and the data sets are preprocessed. The data set parameters can represent the inside complex multi-junction solar cell structure, so as to collect and record a large amount of the data of the multi-junction solar cell structure. Therefore, each of the data set parameters of the multi-junction solar cell structure can be used as a sample, and the multiple data set parameters of the multi-junction solar cell structure can be used as a sample set. Each sample or the sample set can be used as an input layer of the neural network (i.e., KNN).

Step 2: the training data set and the test data set constructed in the step 1 are preprocessed to obtain a preprocessed training data set and a preprocessed test data set. The pre-processing method includes the following steps:

(1) In the constructed data sets, the input feature parameters of the solar cell structures, the output feature parameters corresponding to the input feature parameters, and the input feature parameters of the to-be-predicted multi-junction solar cell structure are screened to obtain feature data according to known physical knowledge and a relationship (i.e., correlation coefficients) between the feature data.

(2) Normalization processing is performed on the screened feature data, and a specific calculation formula of the normalization processing is as follows:

$${x}^{′} = \frac{x - μ}{σ} ,$$

where μ represents a mean value of the samples, and a represents a standard deviation of the samples. The normalization processing is performed on the screened input feature data, so that a mean value of the processed feature data in each dimension is 0, a standard deviation of the processed feature data is 1, and the input feature data obeys standard normal distribution.

(3) Data recombination: the processed feature data is recombined according to a size of each of the processed feature data, and then is performed multi-batch division.

It should be further noted that, since input dimensions required in a two-dimensional convolutional neural network are 4D (containing: samples, rows, cols, channels) and the training data set in the embodiment is an array read from a txt form file, an arrangement mode of the training data set needs to be adjusted, so that the training data set is matched with the input dimensions of the two-dimensional convolutional neural network.

Step 3: a k-nearest neighbor model is constructed by using the k-nearest neighbor algorithm based on the machine learning algorithm.

Step 4: structural parameters of the constructed KNN model are set and initialization training is performed on the set structural parameters to obtain an initialized KNN model.

A method for setting structural parameters of the constructed KNN model includes: the number of neighbors used for querying of 3, and weights of all points in each neighborhood being the same.

Step 5: the initialized KNN model is trained and optimized by using the input feature parameters of the multi-junction solar cell structure preprocessed in the step 2, and a network weight and a bias of the initialized KNN model are obtained and stored, so as to obtain a KNN prediction model. Specially, the preprocessed training data set composed of the input feature parameters of the multi-junction solar cell structure and the screened output feature parameters corresponding to the input feature parameters.

In the embodiment, a root mean square error is used to measure a loss (gap) between a model output value and a target value. Based on the above, in the step 5, the loss function of the KNN model during the training process is evaluated by using a mean square error (MSE), so as to determine the quality of a training result of the KNN model. A formula for the mean square error formula is as follows:

$$MSE = \frac{{\sum }_{i - 1}^{N} {( {Predict}_{i} - {Actual}_{i} )}^{2}}{N} ;$$

where Predictᵢ and Actualᵢ represent a predicted value and an actual value of an i-th sample, respectively, and N represents a data number in the preprocessed training data set. The calculated MSE is closer to 0, indicating that the training and optimization result of the KNN model is better, and an accuracy of output results of the KNN prediction model is higher. Therefore, when the performance of the multi-junction solar cell structure is predicted by using the KNN prediction model obtained after training and optimization, the accuracy of the obtained prediction values is higher.

Step 6: the preprocessed test data set containing the input feature parameters of the to-be-predicted multi-junction solar cell structure is used as an input layer to input into the KNN prediction model, so as to output predicted values of output feature parameters of the to-be-predicted multi-junction solar cell structure. The predicted values of output feature parameters of the to-be-predicted multi-junction solar cell structure include, but are not limited to, the short circuit current density (J_{SC}), the open circuit voltage (V_{OC}), and the fill factor (FF) of the to-be-predicted multi-junction solar cell structure.

In summary, compared with the related art, the convolutional neural network model, the multi-layer perceptron model, and the KNN model provided by the disclosure can more accurately predict the parameters such as the short circuit current density (J_{SC}), the open circuit voltage (V_{OC}), and the fill factor (FF) of the multi-junction solar cell structure during the overall scheme design of the multi-junction solar cell structure, so that the prediction results better directs the optimization of the multi-junction solar cell structure design solution, thereby designing the multi-junction solar cell structure with the luminous efficiency meeting the expectation. In addition, the convolutional neural network prediction model provided by the disclosure may further predict the predicted values of output feature parameters of the laser, the detector, etc.

In addition, it should be understood by those skilled in the related art that, although there are many problems in the related art, each embodiment or technical solution of the disclosure may be improved only in one or more aspects, and it is not necessary to solve all the technical problems listed in the related art or in the background technology at the same time. It should be understood by those skilled in the related art that the content not mentioned should not be construed as a limitation to the disclosure.

Although many terms such as new-type solar cells, multi-junction solar cells, machine learning, neural networks, etc. are used herein, other terms can be also used to describe. These terms are used for describing and explaining the essence of the disclosure more conveniently and cannot be interpreted as any additional limitations to the disclosure; the additional limitations are contrary to the spirit of the disclosure. Moreover, the terms such as “first” and “second” (if present) in the specification, the embodiments of the disclosure, and the attached drawings are used to distinguish similar objects, and do not need to be used to describe a specific order or sequence.

Finally, it should be noted that the above embodiments are merely used to illustrate the technical solutions of the disclosure, rather than limiting the disclosure. Although the disclosure has been described in detail with reference to the foregoing embodiments, it should be understood by those skilled in the related art that the technical solutions recited in the foregoing embodiments can be also modified, or equivalent replacement can be performed on some or all of the technical features, and these modifications or replacements do not make the essence of the corresponding technical solutions separate from the scope of the technical solutions of the embodiments of the disclosure.

What is claimed is:

1. A method for predicting performance of solar cell structure, comprising the following steps:
collecting and extracting input feature parameters of solar cell structures, output feature parameters corresponding to the input feature parameters, and input feature parameters of a to-be-predicted solar cell structure; and taking the input feature parameters of solar cell structures and the output feature parameters corresponding to the input feature parameters as a training data set, and taking the input feature parameters of the to-be-predicted solar cell structure as a test data set;
preprocessing the training data set and the test data set to obtain a preprocessed training data set and a preprocessed test data set;
constructing an initial model by using a machine learning algorithm;
setting structural parameters of the initial model, and performing initialization training on the structural parameters to obtain an initialized model;
optimizing the initialized model: training the initialized model by using the preprocessed training data set to obtain a network weight and a bias, thereby obtaining a prediction model; and
inputting the preprocessed test data set into the prediction model to obtain predicted values of output feature parameters of the to-be-predicted solar cell structure.

2. The method according to claim 1, wherein the machine learning algorithm comprises at least one selected from the group consisting of a deep learning algorithm, a multilayer perceptron algorithm, a decision tree algorithm, a linear regression algorithm, a gradient boosting regression algorithm, and a k-nearest neighbor algorithm.

3. The method according to claim 2, wherein the deep learning algorithm comprises at least one selected from the group consisting of a convolutional neural network algorithm, a self-encoding network algorithm, and a deep belief network algorithm.

4. The method according to claim 1, wherein each of the solar cell structures is a multi-junction solar cell structure, and comprises at least one bottom cell and a plurality of sub-cells, and the plurality of sub-cells are disposed above the bottom cell.

5. The method according to claim 4, wherein the bottom cell comprises a substrate, an emissive layer, a window layer, and a tunnel junction that are arranged sequentially in a stacking direction, and the plurality of sub-cells are disposed to stack on the tunnel junction of the bottom cell; and each of the plurality of sub-cells comprises a back surface field layer, a substrate region, an emissive layer, and a window layer that are arranged sequentially in the stacking direction; and an upper sub-cell of the plurality of sub-cells further comprises a contact layer disposed on the corresponding window layer of the upper sub-cell, and each of the remaining sub-cells comprises a tunnel junction disposed on the corresponding window layer thereof.

6. The method according to claim 1, wherein the input feature parameters of the solar cell structures comprise: a thickness of each layer of each of the solar cell structures, stacking modes between layers of the solar cell structures, a shape of each layer of each of the solar cell structures, composition materials of each layer of each of the solar cell structures, and component ratios of the composition materials; and the output feature parameters corresponding to the input feature parameters comprise: short circuit current densities, open circuit voltages, and fill factors of the solar cell structures.

7. The method according to claim 1, wherein the preprocessing the training data set and the test data set comprises the following steps:
screening feature data, comprising: screening the input feature parameters of the solar cell structures, the output feature parameters corresponding to the input feature parameters, and the input feature parameters of the to-be-predicted solar cell structure according to known physical knowledge and a relationship between the feature data;
data processing, comprising: performing normalization processing on the screened feature data to obtain processed feature data; and
data recombination, comprising: transforming or combining the processed feature data in different dimensions to improve an expressive power or reduce a complexity of the processed feature data, and to covert the processed feature data with higher dimension into the processed feature data with lower dimension.

8. The method according to claim 7, wherein after performing normalization processing on the screened feature data, a mean value of the processed feature data is 0 and a standard deviation of the processed feature data is 1.

9. The method according to claim 1, wherein the optimizing the initialized model further comprises:
evaluating a training result of the initialized model by using a mean square error (MSE), wherein a formula of the mean square error is as follows:
$$MSE = \frac{{\sum }_{i - 1}^{N} {( {Predict}_{i} - {Actual}_{i} )}^{2}}{N} ;$$
where Predictᵢ and Actualᵢ represent a predicted value and an actual value of an i-th sample, respectively, and N represents a data number in the preprocessed training data set.

10. The method according to claim 1, wherein the input feature parameters of the solar cell structures and the output feature parameters corresponding to the input feature parameters are screened and adjusted according to a type of each of the solar cell structures.

11. The method according to claim 1, further comprising:
adjusting a design scheme of the to-be-predicted solar cell structure according to the predicted values of output feature parameters of the to-be-predicted solar cell structure.
